(19) United States
(12) Patent Application Publication
(10) Pub. No.: US 2018/0011918 A1
(43) Pub. Date: Jan. 11, 2018

(54) TAXONOMIC CATEGORIZATION RETRIEVAL SYSTEM

(71) Applicants: Grafton V. Mouen, New York, NY (US); William Densmore, JR., Williamstown, MA (US)

(72) Inventors: Grafton V. Mouen, New York, NY (US); William Densmore, JR., Williamstown, MA (US)

(21) Appl. No.: 15/046,851

(22) Filed: Feb. 18, 2016

Related U.S. Application Data
(60) Provisional application No. 62/119,513, filed on Feb. 23, 2015.

(51) Int. Cl. G06F 17/30

(52) U.S. Cl. CPC G06F 17/30598; G06F 17/30867; G06F 17/3053; G06F 17/30554

(57) ABSTRACT

An online content discovery, personalization, predictive, and user enablement system, which uses semantic analysis, word frequency statistics, and a taxonomy of interests hierarchy in order to provide thematic filtering based on a user's personal interest profile. This retrieval system includes a user profile which is transparent to the user and can be viewed, enhanced, and modified by the user, and which is comprised of an aggregation of user identified interests. The retrieval system also includes a presentation of a continuous stream of user-specific personalized content to the user based on the information contained in user's profile. A taxonometric algorithm is used by the system to predict further interests personally relevant to the user and to add the further interests to the user's interest profile upon confirmation from the user thereby improving the user's experience.

### BACKGROUND OF THE INVENTION

The exponential growth of Internet news, entertainment and information has created a problem that challenges everyone. The abundance and diversity of content has increasingly defied efforts to organize it in a meaningful way. For many users of the Internet, much of the online experience is devoted to the process of submitting words to a search-engine, receiving a document list, browsing the list, and then repeating the process.

Such queries generate hundreds of thousands of document links—in effect a new universe of content to search, but without a meaningful strategy for doing so. This is a random and serendipitous process, both frustrating and time-consuming. Some sites allow for the application of a second search string, of date ranges, or of filtering on images or video only. But these strategies, to be effective, require familiarity with the search domain (what hits might be out there) which most users lack.

The problem is acute in the area of news. Beyond breaking news, users are challenged to come up with keywords which will result in hits of interest to them. Important events are covered many times over.

Today, comparable content aggregation sites, for instance Google News, provide users with sliders (or similar) to determine the relative number of articles selected from among traditional news sections, “sports”, “politics”, “local news”, “entertainment”, for example. More customized sections can be included based on keywords. But the strategy is one of erring on the side of inclusion and necessitates a fair amount of browsing. Our invention seeks to deliver a highly valued set of items as one might read one at a time on a phone or tablet as part of a personalized daily briefing.

### BRIEF SUMMARY OF THE INVENTION

LifeStream® is a next-generation approach to online content discovery, personalization, predictive personalization and user enablement, that assembles components of today's best semantic analysis, word frequency statistics, as well as a proprietary taxonomy of interests at several levels of abstraction. It provides thematic filtering from the user's point of view, using labels that a user will readily understand.

LifeStream® anticipates a paradigm shift in which relevant content is actively pushed to the user rather than in response to search-box entry. By constructing comprehensive and detailed interest identities, our service present each user with a highly personalized stream of content without basing each result set on some user activity.

The invention consists of a series of technical innovations addressing the challenge of efficiently producing Web pages that are unique to each viewer based on their interests and preferences. It seeks to provide, on-demand, a continuous stream of online content, news, entertainment and topical articles relevant to all of the viewer's interests with unprecedented precision, eliminating anything off interest and presenting each item of content only once.

The application claims three distinct technologies, 1) An item categorization engine, 2) An interest prediction engine, and 3) a user matching engine.

### BRIEF DESCRIPTION OF THE DRAWINGS

FIG. 1 illustrates LifeStream®'s multi-tiered taxonomy. Life Stream uses a multi-tiered taxonomy as its core retrieval system: (a) A single layer of Identities (b) Multiple layers of “Interests” (c) A single layer of keyword identified sections of content and (d) A single layer of content items.

FIG. 2 illustrates the detailed process of acquiring content, extracting entities to a proprietary interest taxonomy, mapping to content and identity profiles, matching to profiles and then matching the profiles to multi-topic content streams that become tailored to user interests.

FIG. 3 illustrates by means of a black-and-white screen shot the implementation of the Identity Selector Feature.

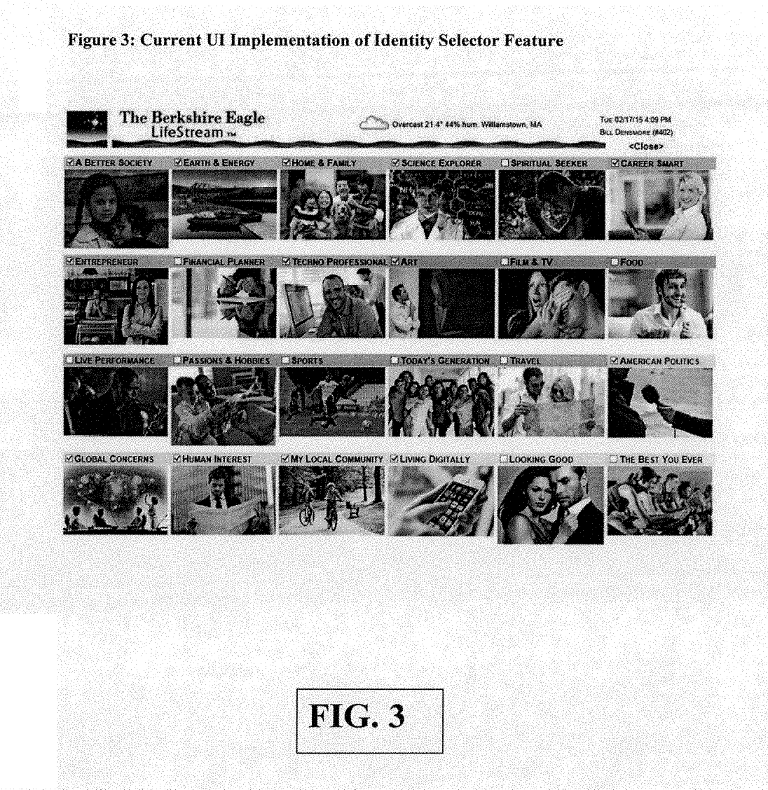

FIG. 4 illustrates by means of table the implementation of the Identity Selector feature.

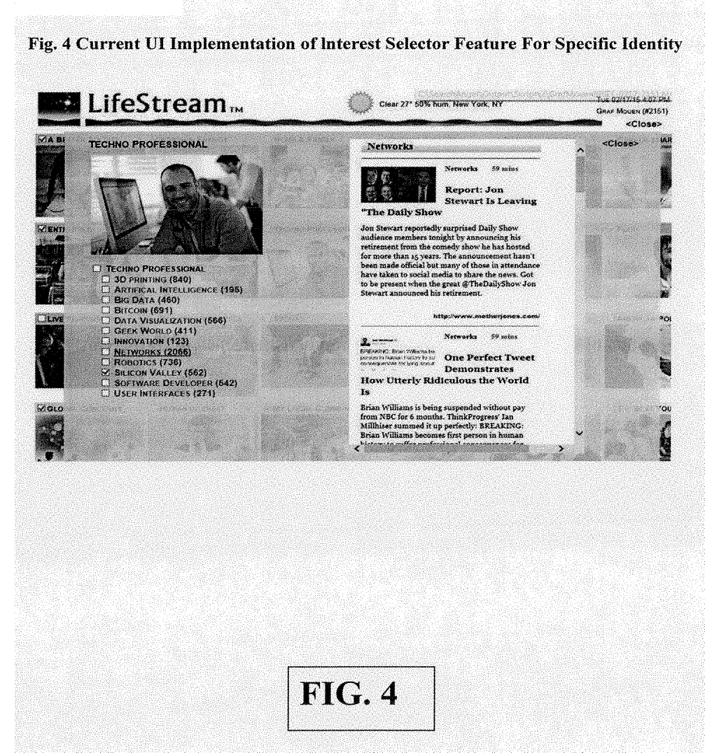

FIG. 5 illustrates by means of a black-and-white screen a user-interface implementation of a Content Browser for Specific Identity.

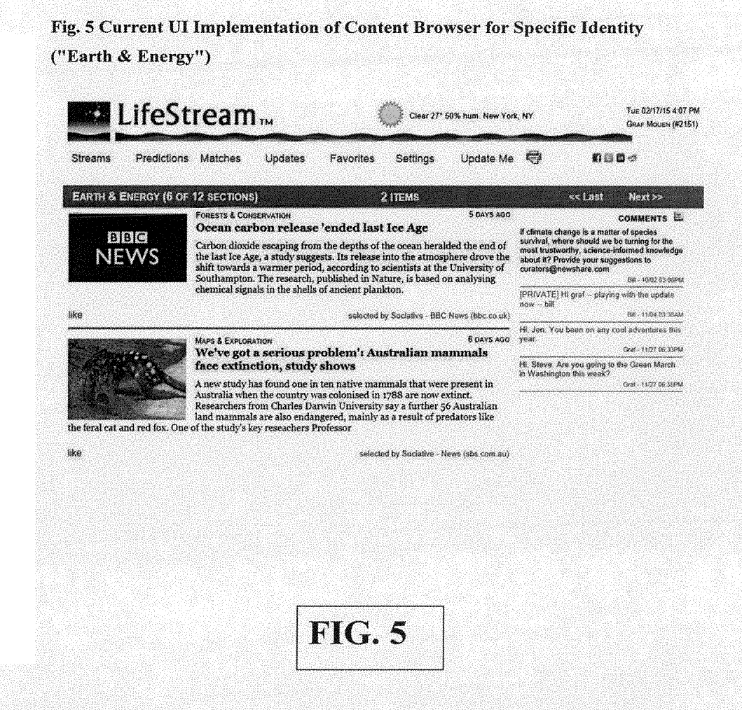

FIG. 6 illustrates by means of a black-and-white screen shot the implementation of Uses Matches based on Identities and Interests.

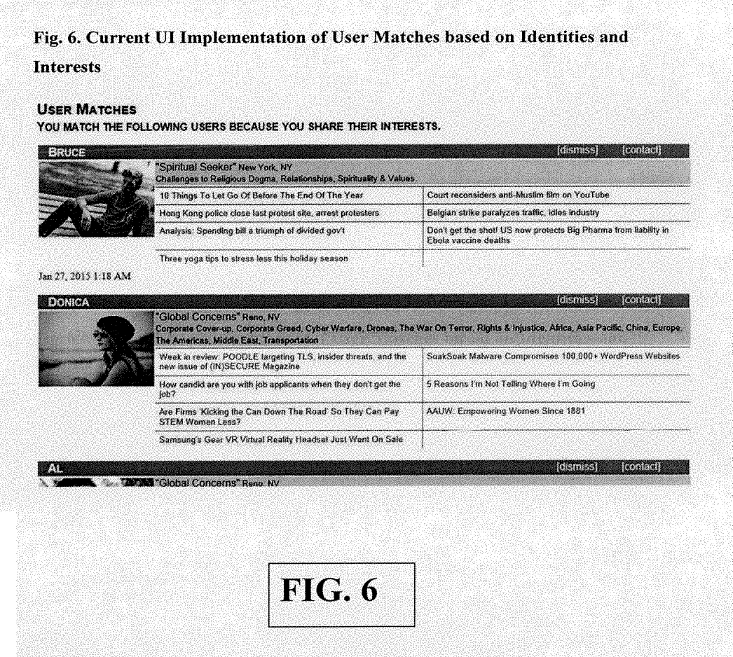

FIG. 7 illustrates by means of table the implementation of interest predictions.

FIG. 8 is a code sample shows a first routine of establishing a user's identities and interests

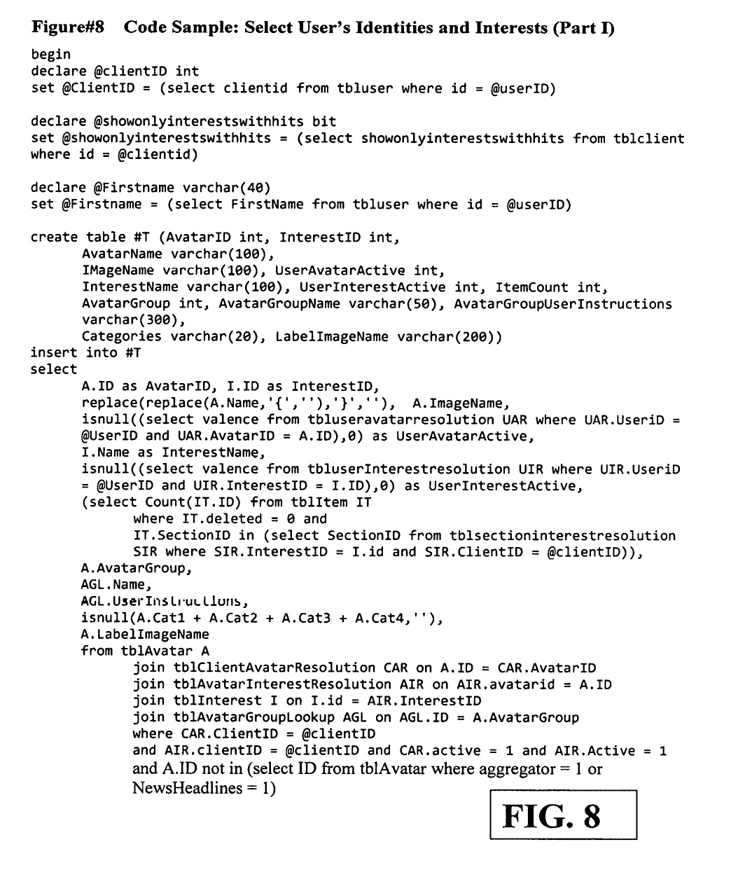

FIG. 9 is a code sampling showing a second routine for establishing a user's identities and interests.

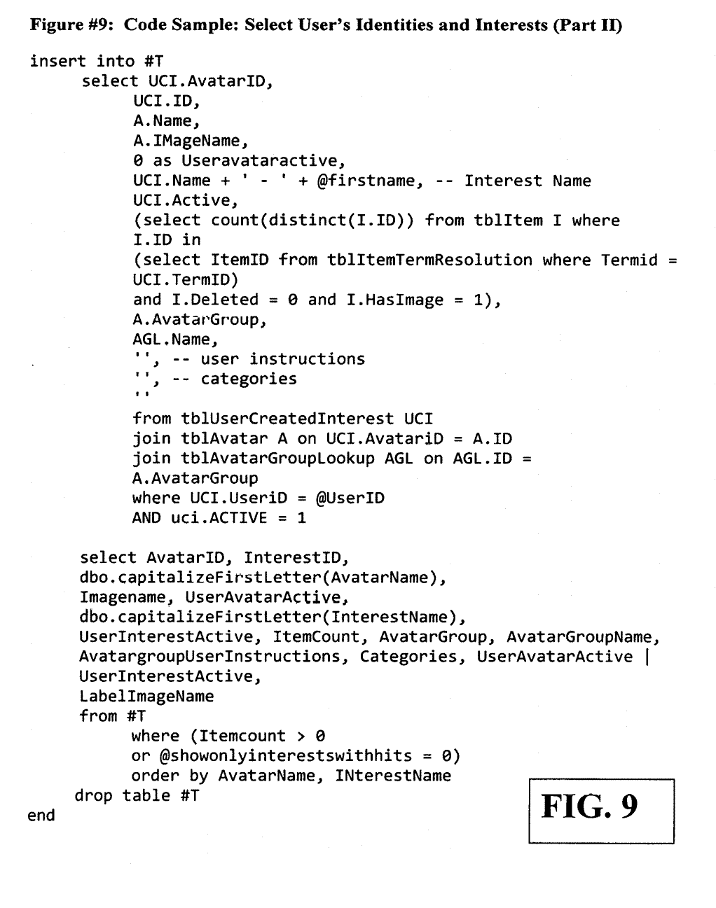

FIG. 10 is a code sample for selecting content items for a single identity

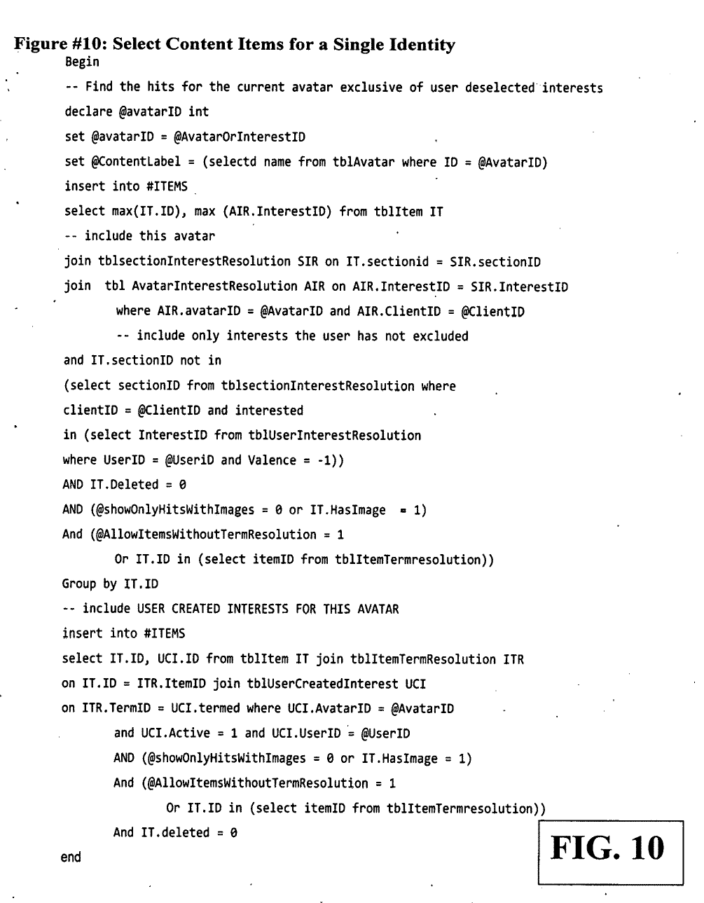

FIG. 11 is a code sample for selecting content for a single interest.

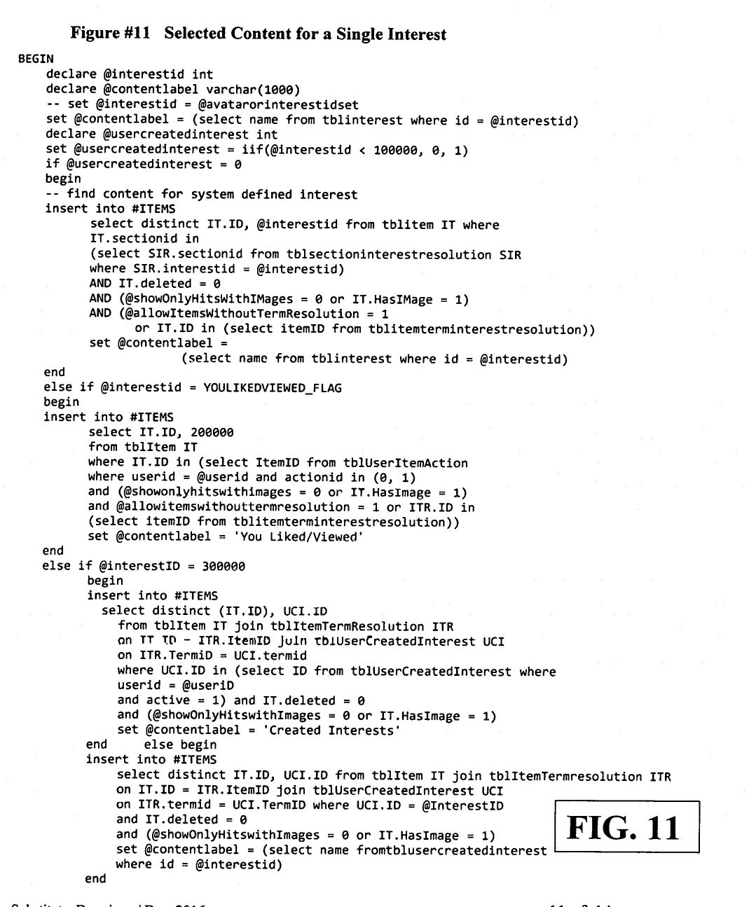

FIG. 12 is a code sample for running an interest prediction based upon a new user's activity.

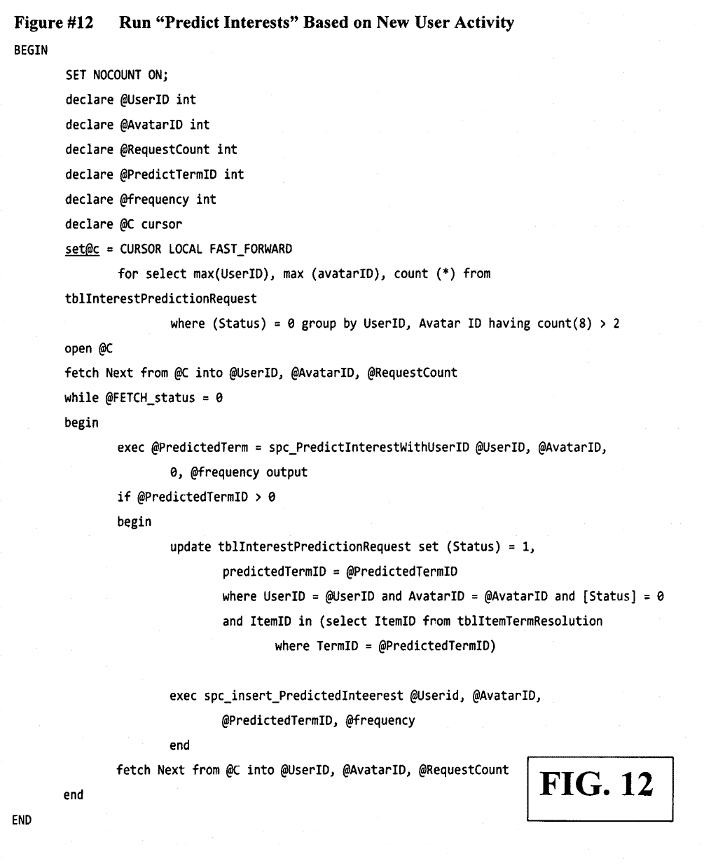

FIG. 13 is a code sample for predicting a single new interest for a given user.

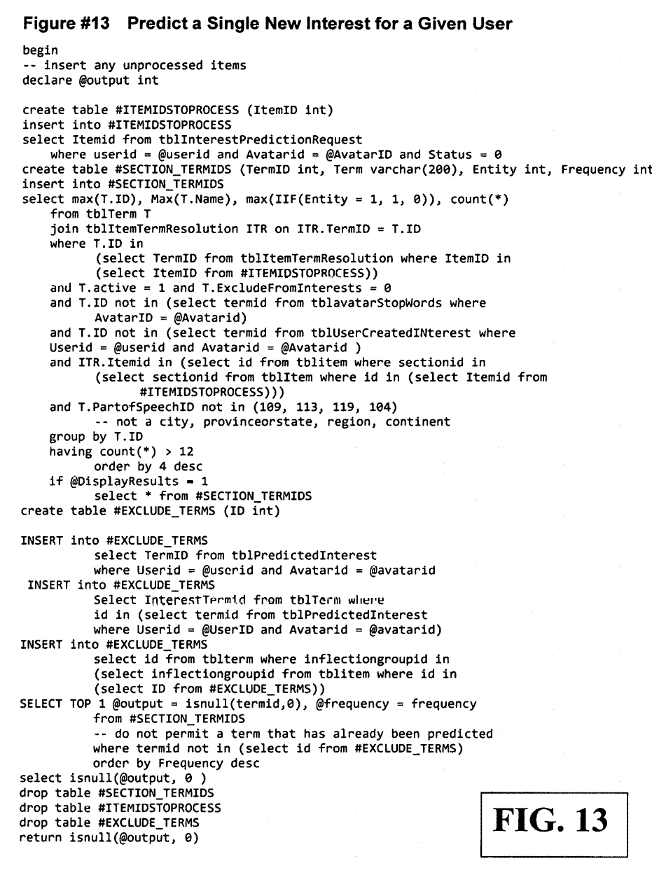

FIG. 14 is a code sample for assigning interests to content items based on training sets.

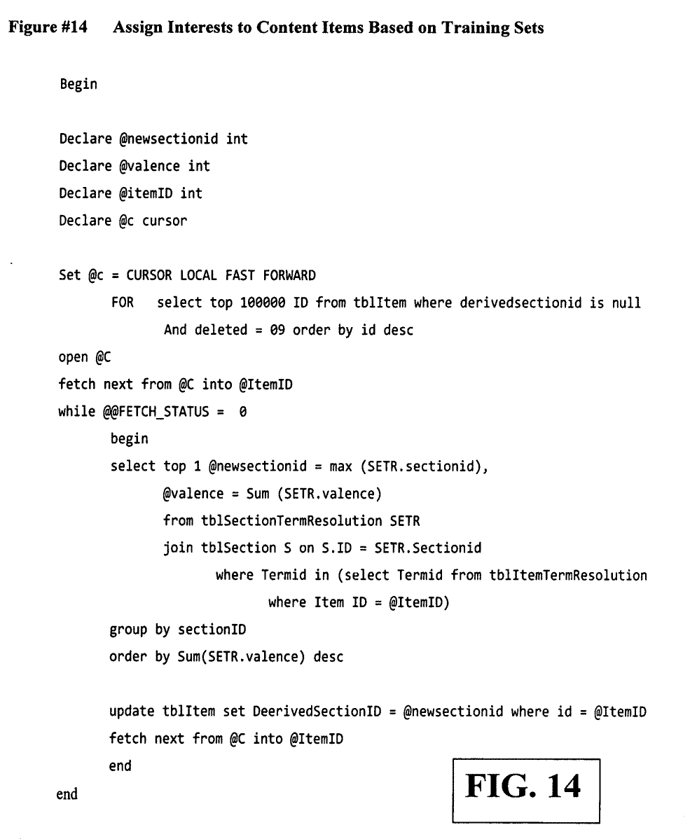

### DETAILED DESCRIPTION OF THE INVENTION

The invention (referred to in this document as “LifeStream®”) is herein disclosed as a series of software modules consisting of:
(1) An analytic step in which items of online information, such as news articles, are semantically parsed and analyzed and assigned to one or more interests in a hierarchic interests taxonomy rendering an interest “profile” to be stored for each,
(2) A series of user interaction steps allowing the system to create a user's unique “interest profile”
(3) A filter step in which a user's interest profile is matched to the repository of content interest “profiles” generating a ranked score for the purpose of presenting items of high relevance to the user.
(4) An interaction step in which the user's behavior viewing items and indicating the liking or disliking of them adjusts the user's “interest profile” for greater refinement of results.
(5) A presentation and interrogatory step in which the system predicts additional user interests, suggests them to the user, and subject to user confirmation updates the “user's interest profile”.
(6) A presentation step in which user “interest profiles” are cross matched resulting in the display of a ranked list of those who share the most interests with the user and an optional maintenance step in which the user can update their profile directly.

### Creating a Personalized Online Experience—“LifeStream®”

The current working implementation of the invention is titled LifeStream®, pointing to the diversity of “life” interests available for inclusion and the continuous stream of highly relevant content that results. LifeStream® creates a continuous stream of content that is unique to each user. Without users having to submit search terms, the system addresses their interests with unprecedented precision using a technology herein described. Using LifeStream®, users create and maintain a highly personalized interest profile that consists of user selected or machine inferred interests from LifeStream's multi-layered proprietary interest taxonomy. There may be many taxonomies simultaneously embedded in the LifeStream® technology, each specific to a domain of human concern.

Such taxonomies of interests aspire, in so far as possible, to comprehensively address each domain without straying outside of it. The current implementation, addresses the domain of personal interests that can be addressed with Internet content from available sources. The end nodes of the hierarchy consist of interest labels chosen to be immediately intelligible to users and as close as possible the way users would naturally describe their interests.

The higher levels of the taxonomy consist of more general groupings. At the highest level are identities or roles descriptive components of a user personality. When taken together, this unique collection of identities and all of the interests they comprise is the user's interest “fingerprint” or “persona”. It is this form of identity/interest aggregation that LifeStream® uses to personalize a selection of content. In this implementation the content is up-to-date news, entertainment, and personally useful information. But the system supports any number of domains.

The current implementation consists of 24 identities, each of which creates a stream of up-to-date Internet content, an “identity stream”. The composite of the user selected identities with (possibly) some user editing of the comprised interests creates a highly personalized experience of content, the user's “LifeStream®”.

The implemented 24 Identities are:
A Better World, Earth Lover, Family First, Next Gen, Career Smart, Entrepreneur, Smart About Money, Techno Professional. Art Lover, Film/TV Fan, Fun Lover, Performing Arts Fan. Sports Fan, Travel Enthusiast, My Local Community, News Savvy, Science Explorer, US Politics, World Citizen, Best Body Ever, Food Lover, Living Digitally, Looking Good

As stated, each of these Identities comprises a set of constituent interests. For example, the “Family First” identity aggregates the following interests, among others:
Alpha Mom, Cycling, Dogs, Gardening, Having Children, Home and Garden, Natural Mama, Weddings, Woodworking.

The user registers interests by 1) directly selecting items from a list or 2) indirectly by answering questions or playing an image, video, or text selection game. In either case, the user is encouraged to navigate through and select from the entire taxonomy, so that the result is a comprehensive interest persona unique to that user.

One of the challenges of the up-front interest discovery process is to make the user's participation an enjoyable experience. (The LifeStream® prototype gives the registered user a lively and highly visual selection of 20 “identities” and 200 “interests” from which to construct a persona.) After the personalized filter is in place, a body of content, already aggregated and categorized in the system's data store, in a manner herein described, can be immediately pushed to the user. While results can be further searched using a traditional text box, no such activity is required of the user to receive the highly personalized LifeStream®. Eliminating the requirement of text entry is especially useful for tablets and cells, where tapping and swiping have replaced most text entry.

LifeStream® is designed to push the content selection, the LifeStream® to the user on a regular basis, once a day or more frequently, on a schedule or on demand. While there are a number of online systems that aggregate and filter content, Life Stream does so with greater precision and facility due to the technology herein discussed.

### Key Elements of LifeStream®

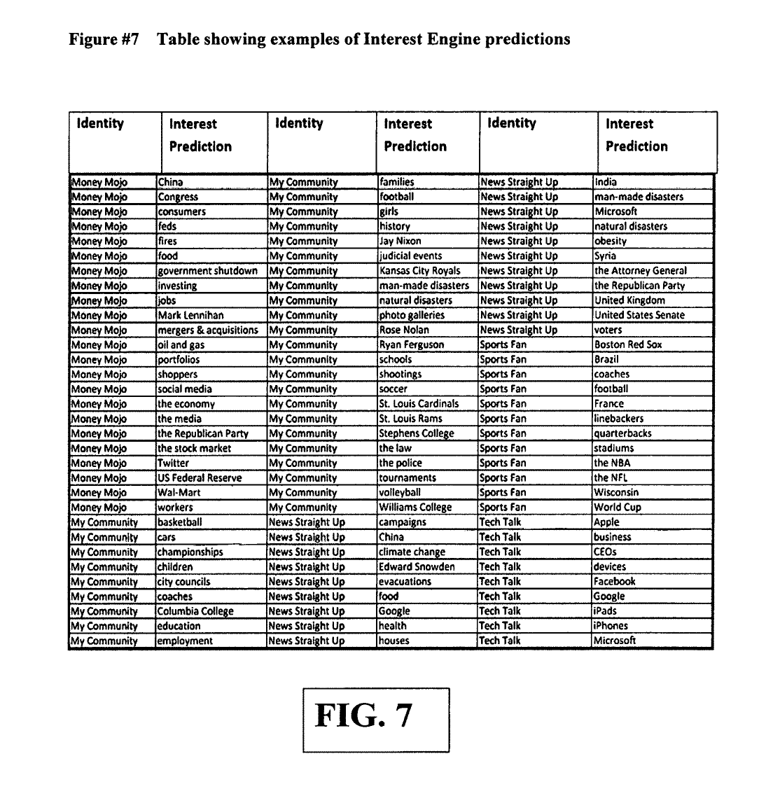

LifeStream® discovers interests within a wide variety of domains. FIG. 7 is a table which illustrates a number of Life Stream® Identities and the Interest Tokens that would be presented, one at a time, to the user by the Predictive Interest Engine. These results were created by a computer simulation: 160 simulated users, each opening 50 content items, half of the items randomly selected from 60,000 items ingested into the system over the last 30 days, the other half chosen from items most recently ingested at the time of the test. The Predictions are unaltered output from the service.
1. The LifeStream® system is based on user interest identification and the creation of a user profile, a persona, aggregating such interests.
2. As LifeStream® develops a continuous stream of user-specific personalized content, it facilitates experience, immersion and high levels of engagement, all but eliminating the browsing of hit lists.
3. Once their persona is in place, the user has a “lean back” experience as relevant content is pushed to the device and alerts are triggered. LifeStream® can update the active “tiles” typical of a modern UI.
4. Instead of merely storing an activity history, Taxonmetric's algorithms are predictive. The system develops “ideas” about a user's interests, and continuously offers suggestions: “Are you interested in . . . ?” The user's persona improves over time.
5. LifeStream® is transparent. Users can view, enhance, modify their interest profile.
6. LifeStream® aspires to be the user's homepage, an online personal assistant or “information valet”
7. LifeStream® develops communities of users around interests, life roles and identities. For many, this would be an advance beyond the “friends” metaphor.

### Identity Discovery and Content-Navigation System

As an identity discovery and content navigation system, Life Stream has several advantages over today's content aggregators and search engines. The system comes “to know” the users and their preferences as interest sets, at many levels of abstraction as needed, expressed in language users can readily understand, allowing them to reconfigure their interest at any time and so be in charge of their interest persona. By continually tracking user behavior the system can come to detect other interests within the taxonomy that the user may have already selected and, subject to user confirmation, adjust the user's filter accordingly.

In the case of a user's fairly static interests over time, Life Stream addresses one of the most challenging aspects of Internet navigation, by eliminating the demand on the user to come up with an optimum text search string, enter it into a search box, and then to browse resulting hits lists one interest at a time.

A user's interest profile, by which the system filters content is a collection of the user's explicit choices and of his or her confirmations of machine-generated interest predictions. Components can be modified or deleted by the user at any time. By creating content streams known to be of interest to a user, Life Stream affords individuals better online time management, especially in respect to interests that are steady over time.

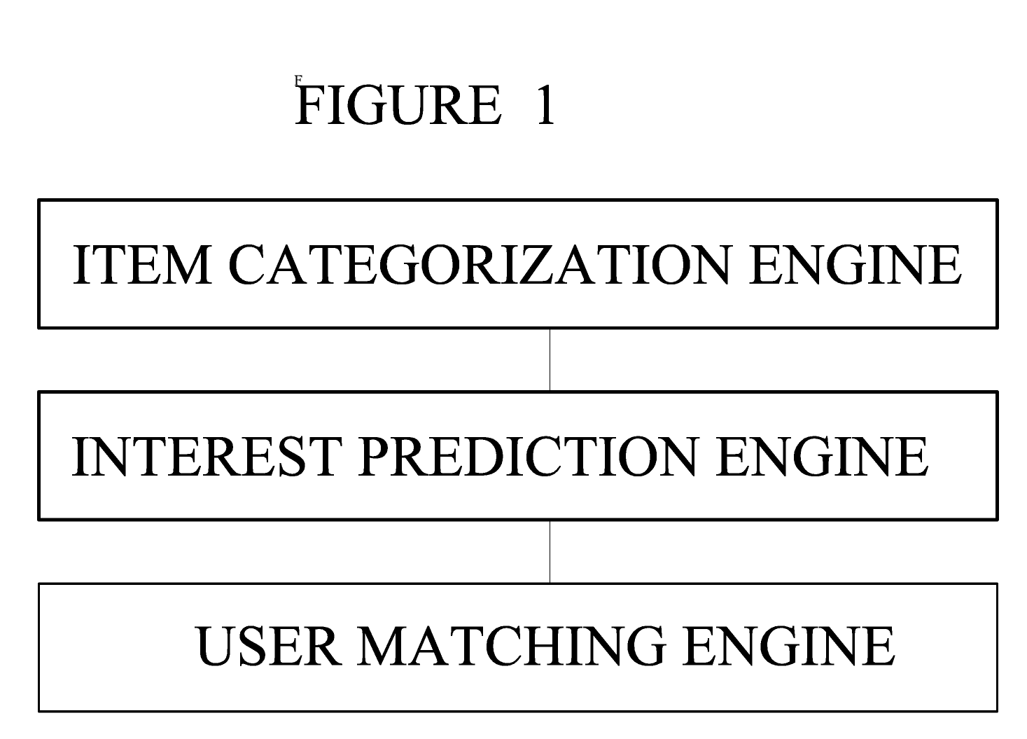

This basis for achieving these results is a multi-tiered taxonomy of interests. As shown in FIG. 1, LifeStream® uses one or more taxonomies to categorize, in real time, news, entertainment, commercial and informational content published to the Internet in a variety of forms such as, but not limited to, news wires and RSS feeds. In the current implementation, several hundred continuous streams of content are available to address a plurality of interests such as jazz music, organic gardening, local schools, children's health and so on.

The system is trained by using sets of theme homogeneous content streams such as RSS feeds that are nearly topic specific. From the training sets, word and phrase frequency profiles are created for each topic interest. Such profiles, once created, can be used to detect and categorize items of content from streams unspecific in topic, for example, a general news stream.

Key assumptions of the design is that a content item is considered in the light of one taxonomy at time, the nodes of which are a finite set of domain-specific interests. The matching of item profile to interest profile (in an effort to find a best fit) results in a set of scores.

The interest-item match score may pass the threshold value for several interests. Such items can be assigned to the broader identity category if the qualifying interests belong to it, or discarded if it has a too diverse set of interest assignments. This would correspond to the human process of weeding out much content that is too broadly defined to interest us. On the other hand, items that do not reach the threshold of any interest are likely to be too narrow in their focus and are also reasonably eliminated.

Key assumptions of the system:
1) that a content item is highly likely to fall within one of the finite number of interest categories, and
2) that for every interest a training set of representative content items can be obtained. The expansion of RSS and topic-specific news wire feeds in the last 5 years support this method.

From each item, a set of tokens (words, phrases, entities, proper nouns) are extracted using syntactical analysis. Items known to be indicative of a single interest category contribute their tokens to that interest's profile, consisting of a list of tokens and their relative frequency within items submitted.

New, uncategorized items can be similarly tokenized and a profile generated, specific to the item. By a process of matching the item profile to all of the interest profiles, taking into account frequency, the best matching interests can be discovered.

If the initial results of the system might be less accurate than desirable, the tokenization of mis-categorized items can be inspected and manual or automatic back-propagated adjustments can be made.

When a new interest is introduced, a significant number of items might need to be reprocessed as a new interest might be a better fit than any pre-existing interest and might displace other interest assignments.

Embedding the interest tokens in a taxonomic hierarchy enhances the accuracy of the system. Interests exist on many levels of abstraction (some folks are interested in baseball, some only in the Yankees, or a particular player). A taxonomy allows highly focused articles (say about a player) to be correctly assigned to all of the parent nodes in the taxonomy, without losing its specificity.

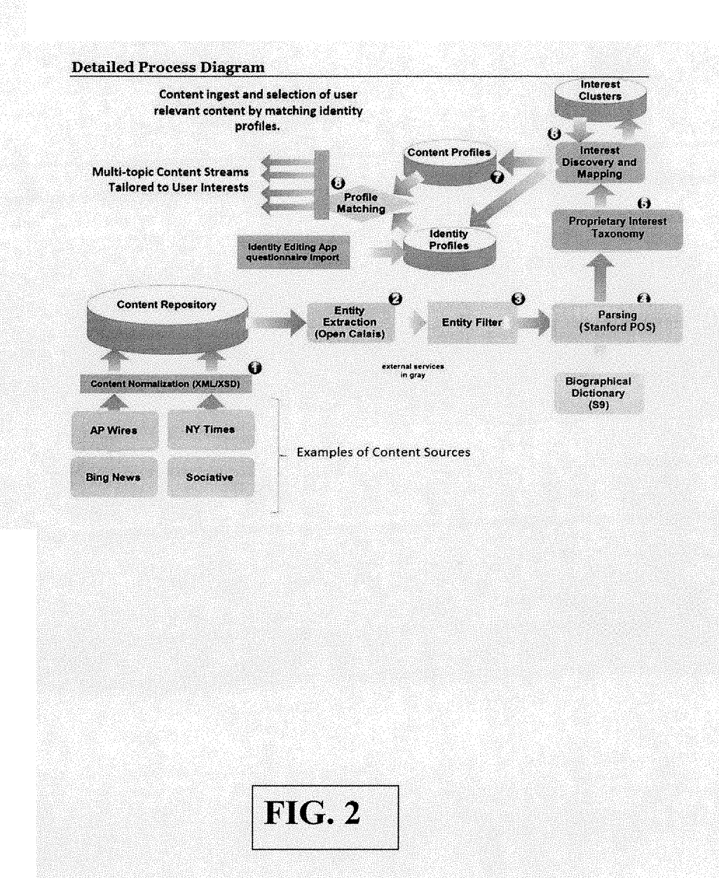

FIG. 2 illustrates in greater detail the steps in the process:
1. Content items are accessed via web services which poll the sources on a periodic basis which. After data normalization to the Life Stream system standard, each item is uniquely identified and stored in the Content Repository.
2. The descriptive natural language text fields are posted to the Open Calais service which returns a package of semantic entities (names, places, institutions, . . . )
3. The entity filter selects for processing only those terms that are useful to the goal of interest generation.
4. Stanford POS breaks words and phrases into Parts of Speech (POS).
5. A special taxonomy that limits itself to describing interests in a hierarchy of decreasing abstraction.
6. The “interest discovery and mapping” component is the heart of the system. Stored in it are clusters of keywords and the rules for applying them to detect “interest” genres. The rules can refer to keywords but also to classes of words and classes of such classes. These are not interests in themselves but are intended to be combined with keywords and biographical/geographical references to create a composite interest.
7. An interest profile is a collection of coded interest ids and proper noun ids which indicate in highly compressed form the content signature of a given article and of a given user or reporter or article in development or newspaper section. These are stored in their respective repositories: content “interests” and users “interests”.
8. When new content arrives it is immediately profiled and matched against all of the user interests in the system to arrive at a match-quotient, a single integer. These are stored in a cross-reference table of users and content where they can be instantly accessed to produce the best fit, the top X content items (newly arrived) in order of interest.

### Establishing and Updating the User's Interest Profile

Several sources contribute to the user's interest profile. In all cases, the system asks for approval of interest profile modifications, additions and deletions. Transparency of the profiles is a key differentiator of LifeStream® from other aggregation systems. It is intended that content is accessed only in reference to an interest profile, either the user's own or one acquired from another user.

User interest profiles are modified in the following ways:
(1) By direct means. LifeStream® displays the identities and constituent interests for users to select from, directly establishing their interest profile. This method is available at all times for users to review and modify their profile.
(2) By indirect means. Users choose their favorites from sets of images, content titles and phrases, to create a set of “liked” items which represent or are derived from the tokens used to differentiate LifeStream®'s identities and constituent interests. In this manner, LifeStream® demonstrates the ability to “magically” infer user interests.
(3) By tracking user clicks indicating “likes” or opening items for view, the syntactical tokens of these choices, once crossing a relevance threshold, prompt the display of interrogative messages, which the user can affirm or decline. For example, a message “Are you interested in ‘starting a family’?” if confirmed would suggest the user has a “Family First” identity and a “Baby” interest.

### Predictive Interests Engine

The “Predictive Interests Engine” uses the same content profile to suggest “likely interests” from the taxonomy for the user to confirm or deny. The source data for making these inferences are the set of user opened and liked items. Interest profiles for this set are aggregated and the most frequently included tokens are matched against those of the predefined interests. The scores are ranked and, after excluding interests already confirmed or dismissed, the results are presented to the user for confirmation.

LifeStream® discovers interests within a wide variety of domains. FIG. 7 is a table which illustrates a number of Life Stream Identities and the Interest Tokens that would be presented, one at a time, to the user by the Predictive Interest Engine. These results were created by a computer simulation: 160 simulated users, each opening 50 content items, half of the items randomly selected from 60,000 items ingested into the system over the last 30 days, the other half chosen from items most recently ingested at the time of the test. The Predictions are unaltered output from the service.

### Matching Users Based on Common Interests

Just as the system matches users with content, it can also match users to one another, using not only their declared interests but also the “liking” or “opening” of content items.

One of the challenges of such matching is that users who have declared many interests or have “liked” many items would, if simply matched 1-for-1 to other users' interests and likes, will have a tendency toward a strong match even if their interests may not be strong. Conversely, people with just a few (strong) interests will have fewer matches. To reduce this bias, the system creates a matching coefficient for each user based on the number of interests and item activity. Highly focused individuals are matched with each other as are broadly interested users.

### Sharing One's User Identity

Once a user has established an interest profile, the system can create for the user on demand, a URL that will link any other individual to the Life Stream system using that user's persona as a filter. Sending this URL via E-mail or IM is a way that the use of Life Stream can spread through a group of friends and friends of friends.

### 1. Performance Enhancements

Challenge: Breaking the unique pages performance barrier. The efficiency of the content selection and display process must reach a performance threshold such that stream of content is available “on demand” to the viewer. LifeStream® claims to advance web site and HTML Email production to this threshold through optimization here described.

### 1.1 Performance Gain: Eliminate the Stack

A principal efficiency gain of the system is derived from the elimination of the middle layers of a typical data rich web page generation “stack”, significantly PHP and other HTML code generators. These layers transform database content, usually stored in a SQL server or similar, into rich HTML web pages. The use of middleware serves to increase the productivity of the programmers of the system at the expense of performance. LifeStream® eliminates all such middle layers and uses a set of reusable SQL procedures to create HTML pages directly. SQL also offers considerable efficiency in the area of personalization where a multi-tiered hierarchical organization of content category tables takes advantage of SQL's query optimizer and the use of table joins and indexes.

### 1.2 Analyse Content Upon Ingest-Current User Items are Always Available

A second efficiency gain derives from having the content assigned, immediately upon ingest, to categories of interests and via collections of interest categories, to viewers. In this way, the CPU intensive aspects of the process are front loaded and impact only the ingest of items to the system, a process that runs, in our instance, for 30 minutes every 2 hours.

The ingest process includes, as a final step, the updating of each current viewer specific relevant item collection available for presentation. When the viewer demands content, no processing other than formatting is necessary.

### 1.3 The Topic Assignment Engine

The current implementation ingests content metadata (title, date, image, synopsis, source, and links to original) from several hundred RSS feeds on a periodic basis (currently every two hours). After eliminating duplicates and conforming the data to an internal standard, items are assigned to topics.

From a source that is topic specific (astronomy, hunting, women's health, etc) items are assigned to similarly named interests.

Items from feeds defined less specifically (ABC News, Foreign Affairs, local news, women's issues) are sent to the Topics Assignment Engine, where they scored against all current topics available by an Interest Detector process which assigns it to one or more interest categories. The Topic Assignment Engine scores the metadata of the item, including synopsis, against a set of “topic profiles”. Having “trained” the engine by syntactical analysis and word frequencies of a series of correctly assigned items, each “topic profile” is sufficient to assign items to topics with a high degree of accuracy.

Note that this topic assignment training requires expert supervision and testing but no viewer activity. Consequently it can be available “on day 1” to the first viewer.

### 1.4 Three Level Taxonomy of Identities, Interests and Topics

LifeStream® utilizes its own carefully constructed proprietary taxonomy of three levels in specifying a viewer's interest in online content. A number of interest lists from librarian, social science, broadcast, publishing and advertising sources have been collated, eliminating minor differences. Online sources, principally wires and RSS feeds have been surveyed to de-activate, temporarily, interests for which content is not available. Each interest label has been vetted to make sure it respects the familiar sense of term used.
Unique to this taxonomy is the use of Identities at the highest level (samples below). These are the labels a viewer might use to describe themselves (“I am a . . . ”) and to introduce the idea that LifeStream® seeks to find people “where they live” in relationship not to the Internet but to the world. The Identities help viewers to navigate and register Interests (samples below) by dealing with one identity at a time. and help discriminate among interests with similar or identical labels. “Accessories” or “Business” or “Education” or “Local Recreation” will stream different content depending on the users registered Identities, say “Young Adult”, “One of the Guys”, or “Prime of Lifer”.
Sample of Identities {28 of 28)

| | | | |
|---|---|---|---|
| Better Society | Gamer/Hobbiest | Local Communitarian | Science Explorer |
| Always Outdoors | News Reader | Looking Good | Self Improver |
| Art Lover | Health Nut | MoneySmart | Spiritual Seeker |
| Career Focused | Home & Family First | Music Lover | Sports Enthusiast |
| Career Smart | Home Community Builder | Next Generation | Young Adult |
| Earth & Energy | Live Performance | One of the Girls | |
| Entrepreneur | Living Digitally | One of the Guys | |
| Foodie | | Prime Of Lifer | |

Sample of Interests {32 out of 240)

| | | | |
|---|---|---|---|
| Accessories | Autos | Big Food | Cats |
| ! Advocacy | Baseball | Biotech | Celebrate Teachers |
| Aerospace | Basketball | Books | Challenges to Dogma |
| Alpha Mom | Beer & Breweries | Breakthrough Ideas | Changing Corp. Culture |
| AP News | Bees | Business | ChannelOne |
| Architecture | Being a Good Teacher | Business Intelligence | Charity Events |
| Arts & Humanities | Best of Science | Cannabis | Children/Child Rearing |
| Astronomy | Better Living | Car and Driver | Children's Health |

### Personalization Strategy

### 2.1 Unique Online Personas

The invention implements personalization across a wide range of content filtering and layout preferences. These choices, either expressed or inferred, constitute the user's “online persona”. Such an online persona could be exchanged with many Internet content and ad providers in a way which preserves the anonymity of viewers while affording unprecedented precision in targeting and formatting ads and content. The viewer's online persona combine two personas: presentation and content selection.

### 2.2 Presentation Personas

The layout preferences define the visual display of content and functionality.

For example, the number and sort order of listed content items, the option of including blogs and editorial comments, the inclusion and size of images, the size and typeface of font, what metadata associated with data should be displayed and whether the page should be dynamically updated with message alerts and notifications generated by the host system, and the times of day for personalized email briefings such as daily updates. Together these constitute the user's “presentation porcona”.

### 2.3 Today's Norm: Passive Personalization and its Deficiencies

The content selection preferences include but are not limited to the registration of keywords of interest to the user. Today, the discovery of such keywords through statistical inferences based on the user's online behavior is what most web sites consider to be the full extent of content personalization.

Google, Amazon and Facebook, and make use of this “passive personalization”. There are companies whose business model is to provide this service in the least obtrusive way, for instance cXense, by simply adding a short script to each page. Among the deficiencies of this brute force strategy are an unspecifiable delay in the effects of personalization (while the system is trained), an overshadowing of long term by short term interests, the discovery of keywords which aren't really indicative of interests, and the lack of ability for the viewer to have any hand in the process.

### 2.4 Transparent and Accessible Interest Personas

To remedy these deficiencies the invention employs a hierarchical tree of human interests intended to be as comprehensive as possible, defined in reference to such lists as exist in the psychological, sociological and marketing literature. It is from this “taxonomy of interests” that users explicitly define their “interest persona”, either directly from interacting with a sequence of views of partitions of the taxonomy, from suggestions, call them “interest predictions”, made by the system and confirmed by the viewer, or from a “game”, for example, a series of questions (like 20 questions) or a set of preference comparisons (which do you like better?). The invention allows the user to update their “selection persona” at any time. Viewers may also exclude specific content sources.

### 2.5 Targeting Ads

The viewer's personas may serve a number of purposes outside of LifeStream®. With the viewer's approval, It can be accessed via API by an ad exchange to more precisely target advertising as it appears on client and non-client sites. It has heightened value and CPM as it features only confirmed interests.

### 2.6 Matching Viewers on Interests

Viewer personas, consisting of a collection of interests, are matched, interest to interest allowing the system to identify pairs of viewers with maximum interest compatibility. LifeStream® notifies viewers via email or IM of prospective pairings and identifies articles both parties have opened or liked.

### 2.7 Sharing Interests

It can be transferred from a viewer to a prospective or new viewer to give them a start on their own persona. It can be established and modified and locked in whole or in part by the client on behalf of all of its viewers in the case of a corporate information resource curated “from above”.

### 2.7 Entirely New Content on Each Visit

One of the frustrations of most sites is that one must revisit them find what's new. And then we have to go digging for it! LifeStream can produce a page or email briefing that contains nothing but content new to the viewer, that is, content that has not been included in a previous presentation. An archive of the most recent presentations is maintained so there is a way to look back to content missed.

### 2.9 Source Rotation

One of the challenges of a multi-sourced content collection is that some sources far outstrip others in the number of items available for ingest. To compensate for this, the system must select items based on a rotation of sources. Such a rotation is extremely efficient using the SQL “PARTITION OVER” command. Each user can option out of source rotation or indicate which sources are to be filtered out.

### 3. Benefits to a Community of Viewers

The technology is “white labelled” and can be configured on every level by a “client” (ex: newspaper, consumer brand, membership organization) to serve a community of viewers, satisfy their interests, and promote their engagement.

### 3.1 Shared Centralized Resources—No Client Build

LifeStream® is designed to accommodate an unlimited number of communities of viewers within a single SQL database. Each such community constitutes a single “client”, for example, the Berkshire Eagle, Honeywell Corp, the Ohio State Teachers Association, the Girl Scouts. For these client organizations, the value of the invention has many aspects: They do not have to provision a database server of their own. They can take advantage of all of the interest categories already defined and populated with content, making a selection of interest categories appropriate to their community, the “client interest persona” from which their viewers' defined interest personas will be a subset. They can add interests specific to their communities which become part of the increasingly comprehensive content collection benefiting all clients. With the viewer's permission they can transfer all or parts of the viewer's preference persona to another client,

### 3.2 User-Friendly Interest Mapping Spreadsheet

The labeling of identities and of the interests that map to them (in an instance of LifeStream®) can always be updated by adjustments to the Interest Mapping Spreadsheet spreadsheet specific to each community of viewers. A client, for instance “The Berkshire Eagle”, would designate a chief LifeStream® curator, whose responsibility would be to align the spreadsheet and therefore be in tune with the changing interests of his community

### 3.3 LifeStream® as a Corporate Resource Organizer

One of the potential uses of LifeStream® is to organize the text, image, and video resources of an organization dependent on the unique experience or expertise contained in these resources. ABC News depends on its collection of thousands of hours of broadcast quality video captured over the last 50 years, organized into relevant subject (interest) categories. A world-class engineering service provider like Honeywell has a similar number of documents online in support not only of engineering, per se, but relevant to professional and personal life in the 50 countries where employees find themselves.

LifeStream® could also provide a daily briefing of news relevant to the entire enterprise or to divisions thereof.

Those in charge of research, recruitment and brand management could fill a curation role in selecting sources, mapping the content to relevant interests and gathering the interests into identities or personal facets.

### 3.4 Giving Viewers a Reason to Revisit a Client Site

One of the challenges faced by any organizational site is that most of the site does not change often enough.

Therefore users have no strong reason to revisit the site. Through it's own RSS Feed, LifeStream® makes it possible for such client sites to select, possibly curate, and present on its own site a frequently updated stream of content of known interest to its community. LifeStream® also allows them to have a daily email update inclusive of links to their own pages.

### CONCLUSION

What has been described is a next-generation system for acquiring, refining and responding to user information preferences within news and other areas of topical interest in entertainment and online information. The system is intended to facilitate acquiring the user's interests, both directly (user's manual selection) and indirectly (inferences and expressions of interest) and interweaves these with proprietary methods for taxonomy-based organization of multimedia information content.

1) A taxonomic categorization of online content retrieval system, comprising
a) an item categorization engine,
b) an interest prediction engine, and
c) a user matching engine.

2) A method of providing a taxonomic categorization of online content retrieval in support of personalization and user matching, comprising:
a) an analytic step in which items of online information, such as news articles, are semantically parsed and analyzed and assigned to one or more interests in a hierarchic interests taxonomic rendering an interest “profile” to be stored for each,
b) a series of user interaction steps allowing the system to create a unique user's interest profile,
c) a filter step in which a user's interest profile is matched to the repository of content interest profiles generating a rank score based on user interest relevance for the purpose of presenting items of high relevance to the user,
d) a user interaction step in which the user's liking or disliking of a presented item is used by the system to adjust the user's interest profile causing an improvement in the relevance of further presented items,
e) an interrogatory step in which the system predicts additional user interests, suggests them to the user, and updates the user's interest profile based on the user response,
f) a presentation step in which multiple user interest profiles are cross matched resulting in a display, to a particular user, of a ranked list of other users who share that user's interests, and
g) a maintenance step in which a user can update their user's interest profile.
